(19) United States
(12) Patent Application Publication
(10) Pub. No.: US 2021/0292130 A1
(43) Pub. Date: Sep. 23, 2021

(54) CONTROL APPARATUS FOR INDEPENDENTLY MOVING HANDHOLDING SUPPORT OF MOVING PATHS

(71) Applicant: Wai Kuen Chan, Hong Kong (HK)

(72) Inventor: Wai Kuen Chan, Hong Kong (HK)

(21) Appl. No.: 16/821,082

(22) Filed: Mar. 17, 2020

(51) Int. Cl. B66B 25/00; B66B 23/04; B66B 21/02

(52) U.S. Cl. CPC B66B 25/00; B66B 21/02; B66B 23/04

(57) ABSTRACT

In a control apparatus for a moving path, directional indicators comprise indication placed on moving handholding support permit discernment of the type of walk/stand traffic from a distance, passenger detecting devices monitor the absence/presence of a passenger within walking zones on an entry gate side and an departure gate side including floor boards of the entry gate side and the departure gate side, and the absence/presence of a passenger within walking zones on the entry gate side and the departure gate side adjacent to and beyond the walking zones. When a passenger is detected in the walking zone on the entry gate side in a conveying mode, a mode switching circuit switches the operating mode to an entrance alert mode, and when a passenger is detected in the walking zone on the departure gate side in the conveying mode, the mode switching circuit switches the operating mode to an exit alert mode.

### FIELD OF THE INVENTION

The present invention relates generally to moving paths and other mechanisms for the automated transport of people between horizontally displaced positions. The present invention relates more specifically to a control apparatus for a moving path in which a plurality of moving handholding support operating at a different speed.

### BACKGROUND OF THE DISCLOSED TECHNOLOGY

One of the most common mechanisms for moving people across long distances within a single floor of a building is a moving path. Such automated transport mechanisms are well known and are particularly common in large open public areas such as airport terminals and shopping malls. Moving paths are frequently used in such environments because of their ability to safely and quickly move large numbers of people between levels or floors or across a single floor within the public space. A moving path is a continuous, high volume way of moving people efficiently. For efficient flow of traffic and common etiquette, fast-moving walkers and standing passengers are encouraged to share one path by utilizing two opposite sides of the same path. (i.e. walk-left and stand-right, or walk-right and stand-left).

Conventional safety tips teach passengers to grasp the handholding support as stepping promptly onto a path, always face forward and keep a steady grip on the handholding support during the transit. Traditionally, floorboards and handholding support are designed to move at the same speed and are driven by the same electric motor. The fact that faster-moving walking passengers walk at a speed faster than the floorboard speed has become a safety issue.

International standards require that the speed of the handholding support shall not change when heave weights are applied against the speed of foot traffic. The stand-traffic handholding support will ideally move at the same speed as the steps. The handholding support drive runs off the step drive, so the handholding support should always match its speed. The motor connects to a drive gear that moves the steps, and from there a belt turns a wheel that drives the handholding support.

Moving paths that are installed under the standards require that a handholding support-speed monitoring device be installed. If the speed of a handholding support changes by more than a certain percent, all power is removed from the motor drive and the brakes are applied. The standards require that the handholding support speed should match the floorboard speed to within a certain percent of margin error.

A major advantage of a moving path or moving sideway in the environment described above is always moving at the speed of foot traffic that the passengers desire. It seems eminently fair to allow those people who'd prefer to let the machinery do all the work relax to one side while those in a hurry squeeze by on the other side. A major disadvantage, on the other hand, is difficult for those other fast-moving walking people to scoot past tourists and other laggards. There have been ongoing effort around the world to abolish standard moving path behavior. One of the drawbacks of current moving sideway and moving path designs is the limited ability to discern from a distance the speed of stand/walk traffic that a specific side of a moving path is moving. There have been a lack of standard procedures among Asian, Latin American, and European countries. This would not be much of a problem if moving paths were always positioned in pairs, one moving up and the second moving down, but in fact this is seldom the case.

Part of their efficiency lies in the fact that moving sideways and moving paths are continuously running in a specific direction or across and do not require the selection of a speed of foot traffic by the user. Moving paths function well because they are fully automated and require little or no control from the passengers utilizing them for transport. This is contrasted with an elevator wherein the passenger is free to access any elevator and then choose the speed of foot traffic upon selecting a specific floor destination.

It is not uncommon for a potential moving path passenger to view a moving path from a distance across a large open public area and perceive it to be moving in a desired direction, only to arrive at the moving path and find that they were mistaken. Likewise, with moving paths, it is difficult for a potential passenger to discern from a distance the stand/walk speed of foot traffic that a specific device is moving. Although moving paths are more often associated in pairs moving in opposite directions, this is not always the case. It is desirable to have an indication of the speed of stand/walk traffic such that an unnecessary approach to the path can be avoided. Certainly where paths are associated in pairs and one is traveling one way and the second the opposite way, it is most beneficial to view from a distance the speed of foot traffic such that an approach to the appropriate path can be made.

The typical moving sideway or moving path has two basic moving components, the moving set of steps or foot platforms and a pair of moving handholding support. The remaining operational components such as the motor and the track structures are stationary. A potential passenger approaching a moving path will attempt to discern its speed of stand/walk traffic by looking at one or both of the moving components. Unfortunately, the moving steps of a typical moving path are most commonly constructed of dark, unfinished metallic material with dark, often corrugated upper surfaces. Because the outward facing surfaces of the moving steps are either constantly in contact with passengers feet, or are constantly rubbing against each other in their progression around the moving path track, it is not practical to provide distinctive features thereon that might serve to indicate the speed of stand/walk traffic for the moving path when in motion. Such distinctive visible surfaces would quickly become indiscernible from the constant abrasive contact they endure.

The moving handholding support of the typical moving path are seldom any better for allowing the distant viewer to discern the speed of stand/walk traffic that the moving path is traveling. Typically these handholding support are constructed of a durable, flexible, plastic or rubber compound of a single color, most often black or gray. It is next to impossible to discern from a distance the speed of stand/walk traffic that such a featureless surface is moving.

### SUMMARY OF THE INVENTION

A moving path is a continuous, high volume way of moving people efficiently. For efficient flow of traffic and common etiquette, fast-moving walkers and standing passengers are encouraged to share one path by utilizing two opposite sides of the same path. (i.e. walk-left and stand-right, or walk-right and stand-left).

In the instant disclosure, a pair of handholding support travel independently at different speeds wherein one of the handholding support runs at a fast-moving walk speed while the opposite handholding support runs at the floorboard speed of a moving path. In contrast, conventional safety tips teach passengers to grasp the handholding support as stepping promptly onto a path, always face forward and keep a steady grip on the handholding support during the transit. Traditionally, stairs and handholding support on a moving sideway are designed to move at the same speed and are driven by the same electric motor.

Accident rate is actually a bit less than with normal belt type moving sidewalks; most accidents happen at the end when people are not paying attention and spill off the moving belt, whereas you get a lot of warning from the moving path in the instant disclosure and know the end is near. It is therefore an object of the present invention to provide a directional indicator that permits the discernment of the speed of stand/walk traffic for the faster moving handholding support from a distance.

The present invention provides a plurality of indication on the moving handholding support component of a moving sideway or moving path that is visually contrasted to the primary component material of the handholding support. An indication may be connected to a computer and provides physical sensations which are felt by a passenger manipulating an indication on a handholding support. The computer can issue a command that causes the actuator to output a force on the indicia, conveying a feel sensation to the passenger. Sensors on the indication allow the passenger to influence detection and locating the passenger by the computer, while actuators on the indication allow the passenger to feel force sensations. For example, when a passenger is approaching the end of a moving path, the host computer issues a force command that causes the actuators to create a feel of force sensation that shakes the indication in a convincing manner. Force sensations output by the indication are often predefined, “canned” sensations that are simply output by the indication when instructed by the host computer. The user feels a different force magnitude depending on how fast the actuator is moved, which may cause the force to vary in magnitude and direction. The programmer may determine the parameters and characteristics of the desired force by simply setting parameters to affect the feel of a force as it is actually output on the indicia, easily setting force feedback characteristics to provide a desired force sensation.

An object of the present invention is to provide a moving path control apparatus that simplifies auxiliary equipment and a passenger detecting apparatus which may be applied to such a control apparatus.

To this end, according to one aspect of the present invention, there is provided a control apparatus for a moving path comprising: a control apparatus body for controlling operation of the speed constant moving path in accordance with a plurality of operating modes including a conveying mode for conveying a passenger, a first alert mode for informing a passenger who is about to enter a walking zone on an entry gate side of nearing fast-moving walking traffic, and a second alert mode for informing a passenger who is about to exit a walking zone on an departure gate side of ending fast-moving walking traffic.

According to another aspect of the present invention, there is provided a control apparatus for a moving path comprising: a control apparatus body for controlling operation of the moving path in accordance with a plurality of operating modes including a conveying mode for conveying a passenger, a first alert mode for informing a passenger who is about to enter a walking zone on an entry gate side of nearing fast-moving walking traffic, and a second alert mode for informing a passenger who is about to exit a walking zone on an departure gate side of ending fast-moving walking traffic; a passenger detecting device for distinguishing and monitoring the absence/presence of a passenger within walking zones on an entry gate side and the departure gate side, including floorboards of the entry gate side and the departure gate side; and a mode switching circuit for switching the operating modes in the case where a passenger is detected in the walking zone on the entry gate side in the conveying mode, and in the case where a passenger is detected in the walking zone on the departure gate side in the conveying mode.

### BRIEF DESCRIPTION OF THE DRAWINGS

FIG. 1 is a perspective view of a typical escalator structure showing the present invention incorporated thereon.

FIG. 2 is a top plan view of the handholding support of an escalator or moving path incorporating the directional indication thereon.

FIG. 3 is a plan view showing an entry gate of a passenger conveyor in accordance with an embodiment of the present invention.

FIG. 4 is a block diagram showing a control apparatus for the passenger conveyor,

FIG. 5 is a plan view showing an departure gate of the passenger conveyor.

FIG. 6 is a flowchart for illustrating the operation of the control apparatus at the entry gate side.

### DETAILED DESCRIPTION OF EMBODIMENTS OF THE DISCLOSED TECHNOLOGY

References will now be made in detail to the present exemplary embodiments, examples of which are illustrated in the accompanying drawings. Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

In the instant disclosure, a pair of handholding support travels independently at different speeds wherein one of the handholding support runs at a fast-moving walk speed while the opposite handholding support runs at the floorboard speed of a moving path. In contrast, conventional safety tips teach passengers to grasp the handholding support as stepping promptly onto a path, to always face forward and also keep a steady grip on the handholding support during the transit. Traditionally, floorboards and handholding support on a moving path are designed to move at the same speed and are driven by the same electric motor.

It is an object of the present invention to provide a directional indicator that permits the discernment of the speed of stand/walk traffic for the fast-moving handholding support from a distance. Accident rate is actually lowered. Most accidents happen at the end when people are not paying attention and spill off the moving belt, whereas you get a lot of warning from the moving path in the instant disclosure and know the walk traffic is near.

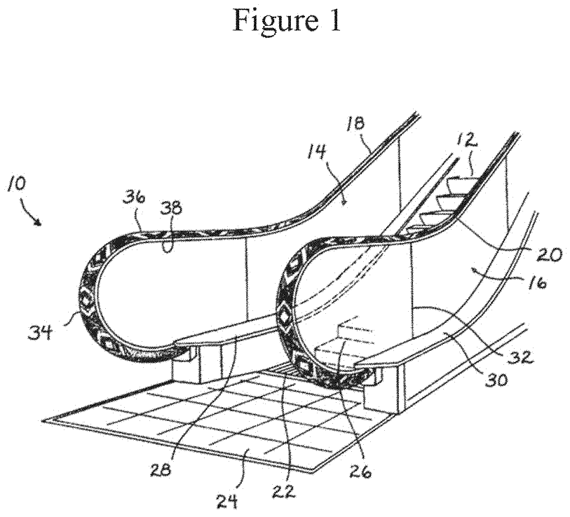

Reference is made first to FIG. 1 wherein a typical moving path arrangement is shown. In this view, the lower end of a moving path that ascends (or descends) between two floors in a building is represented. In this view, moving path 10 is comprised primarily of moving floorboards 12 and sidewalls 14 and 16. Atop each sidewall 14 and 16 are positioned moving handholding support 18 and 20.

An inward platform 22 is shown immediately adjacent to a lower floorboard 26 of moving floorboards 12. inward platform 22 is not in motion but is fixed to an entry/exit floor space 24. On either side of moving floorboards 12, and serving to support and position sidewalls 14 and 16, are base components 28 and 30. To some extent the operational mechanisms associated with moving path 10 are incorporated within the structures shown as base components 28 and 30. The mechanical features of moving path 10 shown are well known in the art and are not modified here by incorporation of the present invention.

Handholding support 18 and 20 in the present invention are improved upon by incorporating the plurality of directional indication 34 as shown. Moving handholding support 18 and 20 each include a continuous loop of flexible handholding support material with an outside exposed surface 36 and in inside surface (not shown) that moves along handholding support track 38. In this manner the outside surface 36 is consistently exposed and directed in a manner that can be viewed by passengers and potential passengers.

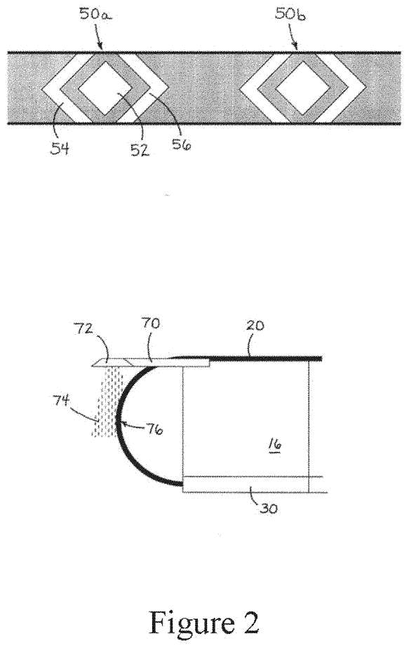

Reference is now made to FIG. 2 for a detailed description of the structure, geometry and function of the directional indication of the present invention. As indicated above, the objective in defining the geometry and coloration of the directional indication is to provide indication that are not only discernable from a great distance but which also permit the discernment of motion from a great distance. In achieving the above objective, the geometric structures shown in FIG. 2, namely partially repetitive, high contrast areas, provide both identification of the indicator and its speed of stand/walk traffic.

Indication 50 a and 50 b are each comprised of geometric elements that contribute to both the discernment of the indicator but also the discernment of the direction the indicator, and thus the handholding support, is moving. Center diamond 52 provides a focal point for the indication comprising a bold, relatively large area of contrast. Arrow elements 54 and 56 repeat part of the form of center diamond 52 in a manner that expands the overall area of contrast and high lights each of the two potential directions of travel.

It should be understood that the geometric shapes shown in FIG. 2 are examples only and do not represent the full choice of appropriate indicia. The shapes shown, however, do provide the basic elements necessary for the indication utilized in conjunction with the present invention, namely a large area of contrast, repetitive spacing, and predisposed directional features. Many other geometric shapes meeting these basic requirements could be utilized.

Further in FIG. 2, for a brief description of an alternative embodiment of the present invention wherein an illuminating device is placed in association with the directional indication so as to assure their discernment in low light conditions. Base component 30 is shown supporting sidewall 16 which in turn supports handholding support 20. Extending from sidewall 16, and electrically connected to a power source there through, is light bracket 70. At the end of light bracket 70 is positioned light source 72 which is directed to shine light 74 down to be reflected off of the surface of a section 76 of moving handholding support 20.

In a first preferred embodiment of the illuminating light source the directional indication positioned on or in the handholding support are designed to be reflective of visible light and preferably light having frequencies generally in the middle of the visible light spectrum. In a second embodiment, the illumination light source emits ultraviolet light and the indication are comprised of fluorescent material that emits visible light when illuminated with ultraviolet light. In either case the objective is to provide sufficient illumination of the indication such that they may be discerned as described herein from a significant distance.

Overall, the present invention serves to make the use of moving sideways and moving path much easier in that it allows discernment of the speed of stand/walk traffic from a much greater distance. In addition, the implementation of the present invention does not require significant effort to retrofit to existing moving sideway and moving path installation. Various means for placing the indication described herein onto or into the moving handholding support will be apparent to those skilled in the art. Adhesive films, paints, inks, and dyes may all be implemented without interfering with the normal mechanical movement of the handholding support about the track.

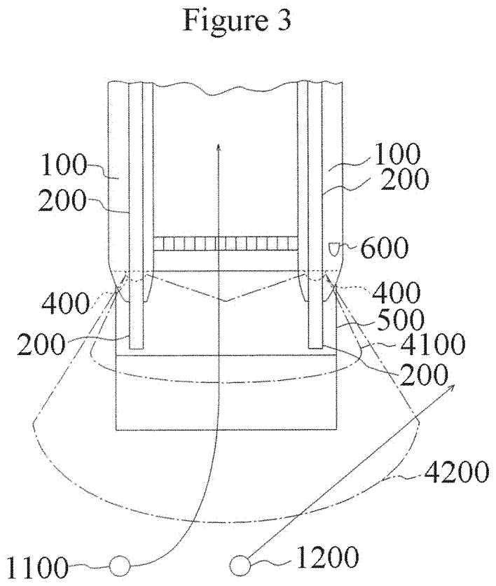

FIG. 3 is a plan view showing an entry gate of a moving path in accordance with an embodiment of the present invention. Moving handholding support 200 are provided on a pair of balustrades 100, respectively. A passenger detecting device 400 for detecting absence/presence of a passenger is provided in a lower portion of a handholding support return port of each balustrade 100. For example, devices having reflective photo detection type sensors with light emitting portions and light receiving portions may be used as these passenger detecting devices 400. Also, devices having ultrasonic wave sensors may be used.

Moreover, the passenger detecting devices 400 monitor to distinguish the presence/absence of a passenger within a first walking zone 4100 at the entry gate side, including an entrance floorboard 500, from the presence/absence of a passenger within a second walking zone 4200 at the entry gate side and adjacent to the outside of the first walking zone 4100 so as to cover the first walking zone 4100. The first walking zone 4100 is a range in which the passenger is about to ride on the moving path from the i.e., a range slightly projecting from the handholding support returning portions 200 at both sides.

The second walking zone 4200 is wider than the first walking zone 4100 in consideration of the approach path of passengers. The first walking zone 4100 and the second walking zone 4200 may partially overlap each other. For instance, the detection range of the moving path in the longitudinal direction is about one meter from the handholding support returning portions 200. Also, the first and second walking zones 4100 and 4200 include a region outside of the handholding support returning portion 200 on both sides of the moving path. Thus, it is possible to detect a passenger who detours around the entrance/departure gates from outside of the handholding support returning portions 200.

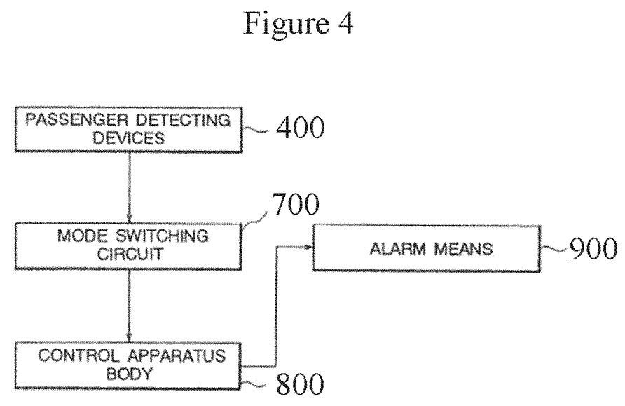

FIG. 4 is a block diagram showing a control apparatus for the moving path shown in FIG. 3. A signal from the passenger detecting devices 400 is output to a mode switching circuit 700. The mode switching circuit 700 switches the operating modes of a control apparatus body 800 in response to information from the passenger detecting devices 400, The control apparatus body 800 controls operation of the moving path with a plurality of operating modes including a conveying mode for conveying the passenger, a first alert mode for informing a passenger who is about to enter a walking zone at an entry gate side of nearing fast-moving walk traffic, and a second alert mode for informing a passenger who is about to exit a walking zone at an departure gate side of ending fast-moving walk traffic.

More specifically, the mode switching circuit 700 switches the operating mode to the first alert mode in the case where a passenger is detected in the second walking zone 4200 on the entry gate side in the conveying mode, and switches the operating mode to the conveying mode in the case where the passenger is detected in the first walking zone 4100 on the entry gate side in the first alert mode.

In the conveying mode, the moving path is operated at a rated speed for only a predetermined period of time for passengers to be conveyed plus an additional period of time. Also, a sensor may be provided on the departure gate side so that the voice greeting is stopped in a predetermined time after the final passenger gets off.

An alarm means 900 for alerting the passengers in the vicinity of the departure gate is connected to the control apparatus body 800. In the alarm mode, the alarm means 900 alerts passengers who are about to exit from the departure gate and informs them that the fast-moving walk traffic is ending. Also, the alarm mode may, for example, alert passengers that the fast-moving walk traffic is ending by means of force feedback on one or more indication without using the alarm means 900.

An indication may be connected to a computer and provides physical sensations which are felt by a passenger manipulating an indication on a handholding support. The computer can issue a command that causes the actuator to output a force on the indicia, conveying a feel sensation to the passenger. Sensors on the indication allow the passenger to influence detection and locating the passenger by the computer, while actuators on the indication allow the passenger to feel force sensations. For example, when a passenger is approaching the end of a moving path, the host computer issues a force command that causes the actuators to create a feel of force sensation that shakes the indication in a convincing manner. Force sensations output by the indication are often predefined, “canned” sensations that are simply output by the indication when instructed by the host computer. The user feels a different force magnitude depending on how fast the actuator is moved, which may cause the force to vary in magnitude and direction. The programmer may determine the parameters and characteristics of the desired force by simply setting parameters to affect the feel of a force as it is actually output on the indicia, easily setting force feedback characteristics to provide a desired force sensation.

The moving path is operated with voice greeting turned off in the conveying mode. When operating in the first alert mode, if a predetermined time usually in a matter of seconds when no passengers are detected in the first walking zone 4100 and the second walking zone 4200 passes, the operating mode of the control apparatus body 800 is returned back to the conveying mode.

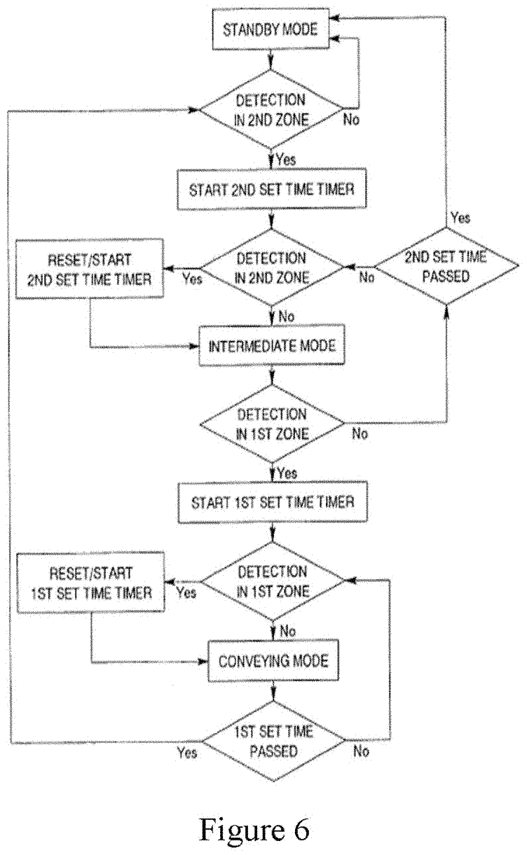

Here, FIG. 6 is a flowchart illustrating the operation of the entry gate side of the control apparatus. The operating mode during standby is the standby mode. The operation of the voice greetings is stopped, and the absence/presence of a passenger within the second walking zone 4200 is monitored. Unless a passenger is detected within the second walking zone 4200, the operating mode remains in the standby mode.

When a passenger is detected within the second walking zone 4200, a timer for a second set time in a number of seconds is started, and the absence/presence of a passenger within the second walking zone 4200 is monitored. At this time, if a passenger is detected, after the timer for the second set time is reset and started, the operating mode is switched over to the intermediate mode. If a passenger is not detected; the timer is not reset and the operating mode is switched over to the intermediate mode.

During low speed operation in the intermediate mode, the absence or presence of the passenger within the first walking zone 4100 is monitored. Consequently, unless a passenger is detected within the first walking zone 4100, the counting operation of the timer confirms whether or not the second set time passes. Then, unless the second set time passes, the intermediate mode is continuously maintained, and the absence/presence of the passengers within the first and second zones 4100 and 4200 is monitored. Also, if the second set time passes while no passengers are detected in the first and second walking zones 4100, 4200, the operating mode is returned back to the standby mode.

On the other hand, during low speed operation in the intermediate mode, if a passenger is detected in the first walking zone 4100, a timer for a first set time in excess of the time needed to convey a passenger is started. Furthermore, the absence/presence of a passenger within the first walking zone 4100 is monitored. At this time, when a passenger is detected, after the timer for the first set time is reset and started, the operating mode is switched over to the conveying mode. Moreover, if a passenger is not detected, the timer is not reset and the operating mode is switched over to the conveying mode.

When the rated speed operation in the conveying mode is started, the counting operation of the timer confirms whether or not the first set time passes. Then, until the first set time passes, the absence/presence of the passenger within the first walking zone 4100 is monitored. Also, if the first set time passes while a new passenger is not detected within the first walking zone 4100, the absence/presence of the passenger within the second walking zone 4200 is monitored. Unless the passenger is present in the second walking zone 4200, the operating mode is returned back to the standby mode.

The operation on the departure gate side will now be described. In the case where a passenger is detected in the second walking zone 4200 on the departure gate side in the standby mode, the mode switching circuit 700 switches the operating mode to the intermediate mode. In the case where the passenger is detected in the first walking zone 4100 on the departure gate side in the intermediate mode, the mode switching circuit 700 switches the operating mode to the alarm mode so that the alarm is generated by the alarm means 900.

In the alarm mode, if the predetermined time when no passengers are detected the first walking zone 4100 and the second walking zone passes, the operating mode of the control apparatus body 800 is returned back to the standby mode.

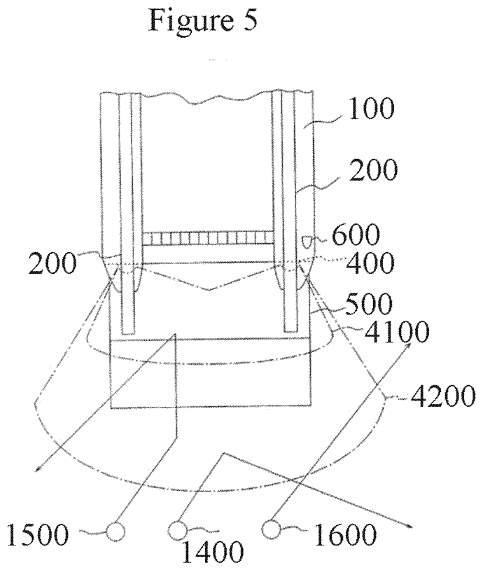

In the case where a passenger 1400 shown in FIG. 5 enters the second walking zone 4200 on the departure gate side in the standby mode, the operating mode is switched over to the intermediate mode. Thus, the low speed operation of the moving path is started. The passenger 1400 can recognize that he was about to exit the fast-moving walk traffic as indicated by the arrow.

Also, in the case where a passenger 1600 shown in FIG. 5 passes across the second zone 4200 on the departure gate side along the path indicated by the arrow, the operating mode is switched over to the intermediate mode and the moving path is operated at the low speed when the passenger 1600 enters the second zone 4200. However, after the set time passes from when the passenger 1600 has leaves the second zone 4200, the operating mode is returned back to the standby mode and operation of the voice greetings is stopped.

Since the low speed operation is started when the passenger reaches a position somewhat away from the entrance or departure gate, it is possible to prevent passengers from mistaking a stand-side of a path with a walk-side of the path. Furthermore, passengers may observe and confirm the operating speed when they enter the second zone 4200. Accordingly, it is possible to use a relatively simplified display device 600 such as the automatic operation display lamp or the operating direction display lamp. Moreover, it is also possible to mount the device on a design element such as the balustrade 100.

Furthermore, when a passenger has passed across the second zone 4200 like the passenger 1200 and the passenger 1600, it is possible that the low speed operation is temporarily performed.

Also, since the first and second walking zones 4100 and 4200 include the region outside of the handholding support returning portions 200 on both sides, it is possible to detect a passenger who takes a detour to the entrance or departure gate from outside of the handholding support returning portions 200 and to dispense with the guide railings.

Further, since the passenger detecting devices 400 having the reflective photo detection system sensors are provided in the balustrade 100, it is unnecessary to provide equipment such as poles to incorporate the sensors.

Furthermore, riding in the wrong direction can be prevented by alerting the passenger even though the moving path stays in the standby mode.

Also, since the ranges of the first and second zones 4100 and 4200 on the entrance and departure gate sides are the same, the structural elements for the passenger detecting devices 400 in the entrance and departure gates may be commonly used. It is therefore possible to facilitate maintenance and adjustment work and the like.

What is claimed:

1. A handholding support mechanism for a speed constant moving walkway with a large number of floorboards being circularly moved along endless paths, the handholding support mechanism comprises:
a pair of handholding supports including a first handholding support and a second handholding support, which operate independently at different speeds, wherein the speed of the second handholding support is higher than the speed of the first handholding support, and the second handholding support comprises a plurality of indicia for distant discernment of the speed of the second handholding support, the indicia comprise sensors and actuators for force sensation input and output;
a control apparatus body for controlling operation of the speed constant moving walkway in accordance with a plurality of operating modes including a conveying mode for conveying the passenger, a first alert mode for informing the passenger who is about to enter a walking zone at an entrance gate side of nearing fast-moving walk traffic, and a second alert mode for informing the passenger who is about to exit a walking zone at an exit gate side of ending fast-moving walk traffic;
passenger detecting devices for distinguishing and monitoring the absence and presence of the passenger within walking zones at an entrance gate side and the exit gate side, including floorboards of the entrance gate side and the exit gate side; and
a mode switching circuit for switching the operating modes in response to information from the passenger detecting devices, wherein
when the passenger is detected in the walking zone at the entrance gate side while the moving walkway is operating in the conveying mode, the mode switching circuit switches the operating mode to the first alert mode, and
when the passenger is detected in the walking zone at the exit gate side while the moving walkway is operating in the conveying mode, the switching mode switches the operating mode to the second alert mode.

2. The handholding support mechanism of claim 1, wherein the second handholding support comprises a plurality of indicia repetitively positioned in generally equal spacing on the entire outer surface of the handholding support, the plurality of indicia receive input from a passenger on a host computer, the host computer commands a type of characterized force sensation output on a force feedback interface device including the indicia graspable by the passenger, the device coupled to the host computer such that actuators of the force feedback interface device output the force sensation on the indicia.

3. The handholding support mechanism of claim 1, wherein at least one of the plurality of indicia comprising a focal point, visually contrasting, geometric shape having a width greater than half a width of the second handholding support.

4. The handholding support mechanism of claim 1, wherein at least one of the plurality of indicia comprises a visually contrasting geometric shape having at least one apex directed along a longitudinal axis of the second handholding support thereby providing a predisposed indication of a speed of stand/walk traffic along the longitudinal axis.

5. The handholding support mechanism of claim 1, wherein at least one of the plurality of indicia comprises contrasting bands generally transverse to the longitudinal axis of the second handholding support thereby providing a stroboscopic effect to the viewer of the indicia.

6. The handholding support mechanism for a speed constant moving walkway according to claim 1, wherein the control apparatus body operates the floorboards at the same speed of the first handholding support, and operates the second handholding support at a higher speed than the speed of the first handholding support.

7. The handholding support mechanism for a speed constant moving walkway according to claim 6, wherein the passenger detecting devices divide the walking zone at the entrance gate side into a plurality of sub-zones with different distances from an entrance gate and monitor the absence and presence of a passenger, and when a passenger is detected in the respective sub-zones, a voice greeting is announced for warning the passenger of walking on the moving walkway.

8. The handholding support mechanism for a speed constant moving walkway according to claim 6, wherein the passenger detecting devices divide the walking zone at the exit gate side into a plurality of sub-zones with different distances from an entrance gate and monitor the absence and presence of a passenger, and when a passenger is detected in the respective sub-zones, a voice greeting is announced for warning the passenger of nearing the end of the moving walkway.

9. The handholding support mechanism for a speed constant moving walkway according to claim 1, wherein the respective walking zones include regions outside of handholding support returning portions on both sides of the moving walkway so that a passenger who detours around the entrance and exit gates from outside of the handholding support returning portions may be detected.

10. The handholding support mechanism for a speed constant moving walkway according to claim 1, including alarm means for generating an alarm in the alert mode, located on both of the entrance gate side and the exit gate side, wherein voice greetings on the entrance gate side and voice greetings on the exit gate side may be automatically announced in response to switching of operating modes of the moving walkway.
